(19) United States
(12) Patent Application Publication
(10) Pub. No.: US 2013/0104344 A1
(43) Pub. Date: May 2, 2013

(54) HINGE-MOUNTED DOOR STOP

(71) Applicant: SILAS BRENT LACY, Springdale, AR (US)

(72) Inventor: SILAS BRENT LACY, Springdale, AR (US)

(21) Appl. No.: 13/281,794

(22) Filed: Oct. 26, 2011

(51) Int. Cl. E05D 11/06; E05F 5/00

(52) U.S. Cl. 16/374; 16/82

(57) ABSTRACT

A door stop installed to hinged mounted door without damaging the door or adjacent structures. The door stop includes a hollow housing having a top end including an aperture, a bottom end, a front face having walls defining an opening, and a back face. The hollow housing is adapted to encase a shaft of a door hinge. A first edge and a second edge are spaced a distance from each other on the front face walls. The edges are configured to receive hinge plates of the door hinge within the distance between the edges and stop the hinge plates from moving within the distance between the edges as a door is moved from a closed position to an open position.

### BACKGROUND OF THE INVENTION

The present invention generally relates to a door stop. More particularly, the present invention relates to a hinged mounted door stop that prevents the door from moving past a predetermined position.

Door stops are commonly used to prevent the door from spreading beyond a predetermined position and damaging the surrounding walls. The prior art shows a variety of door stops. Unfortunately, the current door stops are permanently attach to the door, door frame, walls, or hinge plate damaging the structures. In addition, installing the current door stops require the use of complex tools.

As can be seen, there is a need for a door stop that can be installed to hinged mounted doors without damaging the door or adjacent structures. In addition, there is a need for a door stop that is easy to install and does not require complex tools.

### SUMMARY OF THE INVENTION

In one aspect of the present invention, a door stop includes a hollow housing having a top end including an aperture, a bottom end, a front face having walls defining an opening, and a back face, the hollow housing is adapted to encase a shaft of a door hinge. A first edge and a second edge are spaced a distance from each other on the front face walls, the edges are configured to receive hinge plates of the door hinge within the distance between the edges and stop the hinge plates from moving within the distance between the edges as a door is moved from a closed position to an open position.

In another aspect of the present invention, a stopping system for a door includes a door hinge including a first plate, a second plate, the first plate adapted to be secured to the door, the second plate adapted to be secured to a door frame, the first plate and the second plate including interlocking connections, the interlocking connections of the first plate and the second plate interconnect together forming a hollow shaft; a door stop including a hollow housing encircling the hollow shaft having a top end including an aperture, a bottom end, a front face having walls defining an opening, and a back face; and a first edge and a second edge spaced a distance from each other on the front face walls, the edges configured to receive the hinge plates of the door hinge within the distance between the edges and stop the hinge plates from moving within the distance between the edges as the door is moved from a closed position to an open position.

These and other features, aspects and advantages of the present invention will become better understood with reference to the following drawings, description and claims.

### BRIEF DESCRIPTION OF THE DRAWINGS

FIG. 1 is a perspective front view of a door stop according to an exemplary embodiment of the present invention showing the door stop in use;

FIG. 2 is a detailed view of the door stop of FIG. 1 showing the door stop installed on a hinge in closed position;

FIG. 3 is a detailed view of the door stop of FIG. 1 showing the door stop installed on a hinge in open position;

FIG. 4 is an exploded view of the door stop of FIG. 1; and

FIG. 5 is a cross sectional view of the door stop taken along line 5-5 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a door stop that can be installed to hinged mounted doors without damaging the door or adjacent structures.

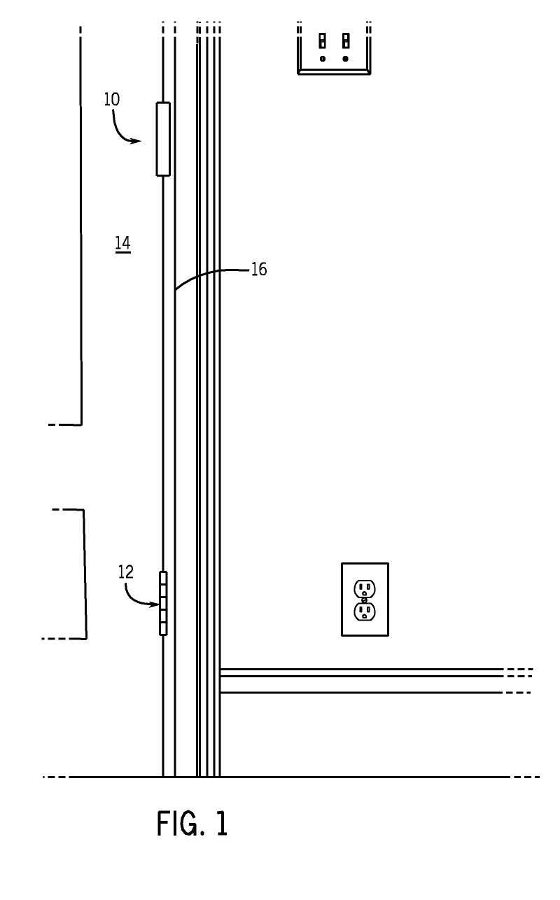

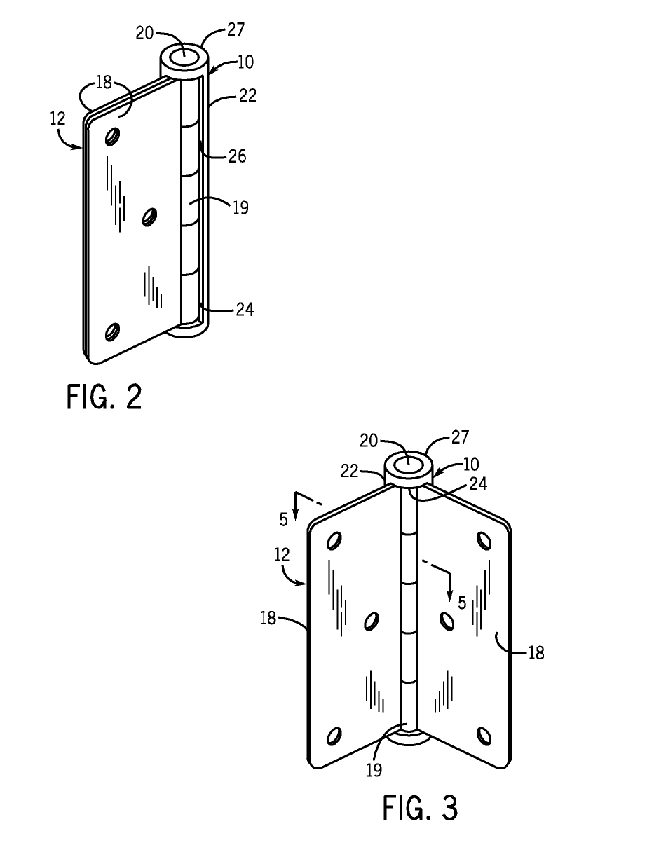

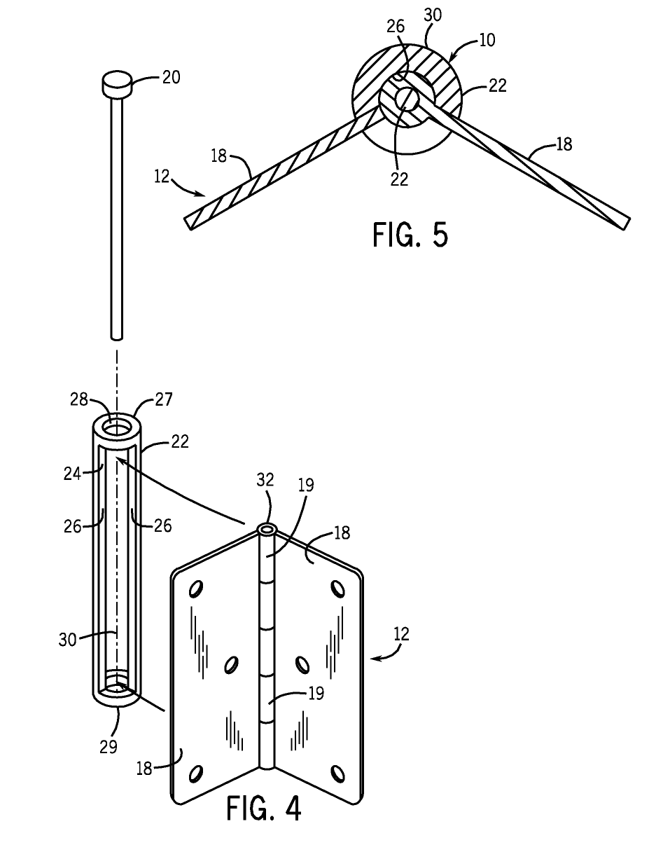

FIGS. 1-5 show a door stop 10 according to an exemplary embodiment of the present invention. The door stop 10 may be mounted on a door hinge 12. The door hinge 12 may have two plates 18. One of the plates 18 may be secured to a door 14 and the other plate 18 may be secured to a door frame 16. The plates 18 may include interlocking connections 19. The interlocking connections 19 of the plates 18 may couple together forming a hollow shaft 32. A pin 20 may be slipped through the shaft 32 allowing the plates 18 to pivot with respect to each other. The door stop 10 may be adapted to encircle the hollow shaft 32 of the door hinge 12.

The door stop 10 may include a hollow housing 22 having a top end 27 with an aperture 28, a bottom end 29, a front face 31 having walls defining an opening 24, and a back face 30. The hollow housing 22 may be a unitary piece housing. The hollow housing 22 may be made of a sturdy material, for example, metal, plastic, polymer, or composite. The hollow housing 22 may have a shape that matches the shape of the shaft 32. The shape of the hollow housing 22 may be, for example, cylindrical. The size of the hollow housing 22 may be slightly larger than the size of the hollow shaft 32.

The opening 24 may include edges 26. The edges 26 may be spaced apart from each other by a predetermined distance depending on the desired distance of stop of the door from a wall. The separation between the edges 26 may be in an arc of about 90 degrees to about 160 degrees from one another.

The edges 26 may work in combination with the plates 18 of the hinge 12 acting as a stopping mechanism to limit the range of motion of the door 14. The plates 18 may be protrude from the opening 24. The plates 18 of the hinge 12 may move within the space between the edges 26 without going beyond the distance between the edges 26.

The hollow housing 22 may include a closed end 30. The closed end 30 may prevent the hollow shaft 32 from falling out the hollow housing 22.

A user (not shown) may remove the pin 20 from the shaft 32. Then, the user may slip the shaft 32 through the opening 24 to the inside of the hollow housing 22. The user may pass the pin 20 through the aperture 28 of the top end 27 of the hollow housing 22.

The door stop 10 may prevent the door 14 from further opening after a predetermined distance, avoiding damage to adjacent walls.

The door stop 10 may be used on cabinet doors, room doors, desk doors, or any surface having a hinge.

It should be understood, of course, that the foregoing relates to exemplary embodiments of the invention and that modifications may be made without departing from the spirit and scope of the invention as set forth in the following claims.

What is claimed is:

1. A door stop comprising:
a hollow housing having a top end including an aperture, a bottom end, a front face having walls defining an opening, and a back face, wherein the hollow housing is adapted to encase a shaft of a door hinge; and
a first edge and a second edge spaced a distance from each other on the front face walls,
wherein the edges are configured to receive hinge plates of the door hinge within the distance between the edges and stop the hinge plates from moving within the distance between the edges as a door is moved from a closed position to an open position.

2. The door stop according to claim 1, wherein the hollow housing is a unitary piece housing.

3. The door stop according to claim 1, wherein the hollow housing has a cylindrical shape.

4. The door stop according to claim 1 wherein the first edge and the second edge are spaced apart from each other from about 90 degrees to about 160 degrees.

5. The door stop according to claim 1, wherein the hollow housing is a cylindrical hollow housing.

6. A stopping system for a door comprising:
a door hinge including a first plate, a second plate, the first plate adapted to be secured to the door, the second plate adapted to be secured to a door frame, the first plate and the second plate including interlocking connections, the interlocking connections of the first plate and the second plate interconnect together forming a hollow shaft;
a door stop including a hollow housing encircling the hollow shaft having a top end including an aperture, a bottom end, a front face having walls defining an opening, and a back face; and
a first edge and a second edge spaced a distance from each other on the front face walls, the edges configured to receive the hinge plates of the door hinge within the distance between the edges and stop the hinge plates from moving within the distance between the edges as the door is moved from a closed position to an open position.
